(19) United States
(12) Patent Application Publication
(10) Pub. No.: US 2026/0228849 A1
(43) Pub. Date: Aug. 6, 2026

(54) SYSTEM AND METHOD FOR PREVENTING GRADIENT-BASED WATERMARK REMOVAL FROM OUTPUTS OF DEEP IMAGE GENERATION MODELS

(71) Applicant: City University of Hong Kong, Hong Kong (HK)

(72) Inventors: Haonan AN, Hong Kong (HK); Guang HUA, Singapore (SG); Yuguang FANG, Gainesville, FL (US)

(21) Appl. No.: 19/330,843

(22) Filed: Sep. 17, 2025

Related U.S. Application Data
(60) Provisional application No. 63/753,424, filed on Feb. 3, 2025.

(51) Int. Cl. G06T 1/00; G06N 3/04; G06T 11/00

(52) U.S. Cl. CPC G06T 1/0021; G06N 3/04; G06T 11/00; G06T 2201/0065

(57) ABSTRACT

A system for secure verification and protection of watermarked images exposed via a decoder interface is provided. The system includes a decoder API module and a gradient monitoring module. The decoder API module includes a decoder submodule and a decoder gradient shield submodule. The decoder submodule is configured to receive a query image and extract a watermark representation using a trained decoder network. The decoder gradient shield submodule is configured to apply controlled perturbations to outputs of the decoder submodule under detection of adversarial query behavior. The gradient monitoring module is configured to observe query inputs and decoder outputs over time, identify characteristics indicative of model extraction attempts, and signal activation of the decoder gradient shield submodule based on detection outcomes.

### CROSS-REFERENCE TO RELEVANT APPLICATIONS

The present application claims priority from a U.S. provisional patent application Ser. No. 63/753,424 filed Feb. 3, 2025, and the disclosure of which is incorporated by reference in its entirety.

### TECHNICAL FIELD

The present invention relates to machine learning and digital watermarking technologies. More specifically, it involves systems and methods for protecting against gradient-based removal of embedded watermarks from outputs of deep learning-based image generation models, by incorporating a decoder-side gradient shielding mechanism within the model's output verification pipeline.

### BACKGROUND

Today's deep learning models can provide exceptional performance across a wide range of tasks, even surpassing human capability. However, these resource intensive models are also subject to the risk of intellectual property infringement. To address this problem, model watermarking has been developed to verify model ownership or detect model theft.

According to how the watermark is extracted, model watermarking can be classified into white-box, black-box, and box-free methods. White-box methods require access to the protected model's internal content in which the watermark is encoded. Black-box methods, also known as backdoor watermarking, require querying the protected model for watermark extraction since they encode the watermark into the model's input-output mapping. Box-free methods, however, extract the watermark directly from the protected model's outputs, which are more flexible and are specially suitable for models that generate high-entropic content, e.g., encoder-decoder image models and generative adversarial networks (GANs). Since only box-free methods embed watermarks into generated outputs, they present a viable solution to the growing demand for AI-generated content attribution.

FIG. 1 shows flowchart of box-free model watermarking for image-to-image models. The thin black arrows represent the black-box querying flow (processing and watermarking), while the thick arrows represent potential watermark extraction, and each thick arrow pair corresponds to a single input-output pair for [symbol] . Considering a model [symbol] that takes an input X₀∈ [symbol] ₀ and generates an output X∈ [symbol] , box-free watermarking creates a watermark encoder [symbol] which embeds a copyright mark image W into X and yields the watermarked image Y∈ [symbol] . A dedicated watermark decoder [symbol] is jointly created and can extract the mark W from the watermarked set [symbol] or a null-mark W₀ from the non-watermarked complement set [symbol] ^{C}. According to the specific image task, ( [symbol] ₀, [symbol] ) can be (noisy, denoised), (original style, transferred style), etc. In the above process, the model [symbol] is protected by only providing Y, instead of X, to the user. It has been verified that if the attacker uses the collection of X₀ and Y to train a surrogate model, W can still be extracted by D from the surrogate output images. [symbol] is referred to as either the protected model or the victim model where applicable.

The attacker has the freedom to alter Y with the hope of removing the watermark while preserving image quality, prior to surrogate training. Intuitively, the alteration can be compression, noise addition, flipping, cropping, etc. Although this vulnerability can be mitigated by adding an augmentation layer between Y and [symbol] when training [symbol] and [symbol] , the attacker can launch a more advanced removal attack by training a removal network [symbol] , as shown in FIG. 2, which shows flowchart of gradient-based removal attack. Adversarial attack literature has shown that the gradient of [symbol] can be estimated via black-box queries, and the gradient can then be used to train [symbol] . Such a gradient-based attack is feasible because [symbol] is jointly trained with [symbol] and contains the watermarking mechanism that can be compensated.

Accordingly, current watermarking solutions in AI model often lack robust defenses against gradient-based removal attacks and the mechanism to protect watermark decoder. Furthermore, advanced defenses against watermark removal often rely on computationally intensive iterative methods that slow down model responses and affect user experience, especially in real-time applications.

Therefore, it is desirable to propose methods and/or devices that can mitigate this vulnerability and address existing limitations associated with current watermark protection mechanisms.

### SUMMARY OF INVENTION

It is an objective of the present invention to provide a system and a method to address the aforementioned shortcomings and unmet needs in the state of the art.

In the present invention, It is first demonstrated that the above gradient-based attack is capable of removing state-of-the-art box-free watermarks. Then, under the practical threat model with the gradient information of [symbol] assumed to be observable to the attacker, a more advanced defense mechanism is proposed, which is called decoder gradient shield (DGS). For non-watermarked queries, the black-box API of [symbol] returns the null watermark output (close to the all-white image W₀) to the users. For watermarked queries, DGS reorients and rescales the corresponding gradient so that when the gradient is backpropagated and used to train [symbol] , the training loss will not be able to converge to the level without DGS protection. Such reorientation is realized by adding specially crafted perturbations on the output of [symbol] while retaining output image quality. Notably, the proposed approach could yield a neat closed-form solution, which is distinct from existing defense or related solutions.

In accordance with a first aspect of the present invention, a system for protecting a watermark embedded in an image output generated by a deep generation model is provided. The system includes an input interface module, an image generation module, a watermark embedding module, a decoder API module, and a gradient monitoring module. The input interface module is configured to receive input data comprising image files, text prompts, structured queries, or combinations thereof, to normalize the input data. The image generation module is configured to apply a deep generation model to the normalized input data received from the input interface module to generate a model-generated image. The watermark embedding module is configured to embed a non-visible ownership watermark into the model-generated image using a predefined watermark pattern to produce a watermarked image. The decoder API module is configured to receive a query image which comprises the watermarked image or a derived version thereof, and to extract a watermark representation from the query image. The decoder API module comprises a decoder submodule and a decoder gradient shield submodule. The decoder submodule is configured to apply a trained decoder network to extract the watermark representation from the query image. The decoder gradient shield submodule is configured to apply controlled perturbations to outputs of the decoder submodule under detection of adversarial query behavior, in which the controlled perturbations modify the outputs of the decoder submodule in a manner that alters gradient direction or magnitude without degrading perceptual watermark quality. The gradient monitoring module is configured to monitor input patterns and decoder outputs received via the decoder API module, and to signal the decoder gradient shield submodule when query patterns indicative of model extraction attempts are detected.

In accordance with a second aspect of the present invention, a method for protecting a watermark embedded in an image output generated by a deep generation model is provided. The method includes steps as follows: receiving, by an input interface module, input data comprising image files, text prompts, structured queries, or combinations thereof; normalizing, by the input interface module, the input data to produce normalized input data; applying, by an image generation module, a deep generation model to the normalized input data to generate a model-generated image; embedding, by a watermark embedding module, a non-visible ownership watermark into the model-generated image using a predefined watermark pattern to produce a watermarked image; receiving, by a decoder API module, a query image comprising the watermarked image or a derived version thereof; extracting, by a decoder submodule of the decoder API module, a watermark representation from the query image using a trained decoder network; and applying, by a decoder gradient shield submodule of the decoder API module, controlled perturbations to outputs of the decoder submodule under detection of adversarial query behavior, wherein the controlled perturbations modify the outputs of the decoder submodule in a manner that alters gradient direction or magnitude without degrading perceptual watermark quality.

In accordance with a third aspect of the present invention, a system for secure verification and protection of watermarked images exposed via a decoder interface is provided. The system includes a decoder API module and a gradient monitoring module. The decoder API module includes a decoder submodule and a decoder gradient shield submodule. The decoder submodule is configured to receive a query image and extract a watermark representation using a trained decoder network. The decoder gradient shield submodule is configured to apply controlled perturbations to outputs of the decoder submodule under detection of adversarial query behavior. The gradient monitoring module is configured to observe query inputs and decoder outputs over time, identify characteristics indicative of model extraction attempts, and signal activation of the decoder gradient shield submodule based on detection outcomes.

The contributions provided by the present invention are summarized as follows.

(1): The vulnerability of the unprotected watermark decoder in existing box-free watermarking methods is identified, wherein the decoder can be exploited via black-box access to train a watermark removal network capable of eliminating embedded watermarks.

(2): A novel DGS framework is introduced to prevent model extraction by protecting the watermark decoder from gradient-based attacks. Integrated within the decoder, DGS disrupts the ability of an attacker to train a watermark removal network using gradient information, thereby safeguarding the embedded watermark in generated images. This approach differs from existing post-hoc methods that rely on extracting watermarks from surrogate models

(3): The proposed method includes a closed-form solution and is validated through extensive experimental results, demonstrating its effectiveness in defending against gradient-based watermark removal. By integrating the DGS into the decoder's API, the system selectively applies gradient reorientation and rescaling based on the nature of incoming queries, thereby maintaining normal functionality for legitimate users while blocking potentially malicious attempts to remove embedded watermarks.

### BRIEF DESCRIPTION OF DRAWINGS

Embodiments of the invention are described in more details hereinafter with reference to the drawings, in which:

FIG. 1 shows flowchart of box-free model watermarking for image-to-image models;

FIG. 2, which shows flowchart of gradient-based removal attack;

FIG. 3 shows flowchart of the proposed DGS in the black-box API of [symbol] according to some embodiments of the present invention;

FIG. 4A and FIG. 4B show demonstration of the convergence behavior of attacker's removal loss functions when training R, under different choices of P;

FIG. 5 shows demonstration of the convergence behavior of the true loss function

$${‖ Z - {W}_{0} ‖}_{2}^{2}$$

after deploying the proposed DGS, under different choices of P, and deraining is considered as an example;

FIG. 6 shows demonstration of the gradient-based watermark removal attack without defense, in which Part (a) is Deraining and Part (b) is Style transfer;

FIG. 7 shows demonstration of the gradient-based watermark removal attack with the proposed DGS defense, where Part (a) to Part (c) are deraining, Part (d) to Part (f) are style transfer, and W is the same as in FIG. 6;

FIG. 8 shows demonstration of the robustness of the proposed DGS when the attacker applies gradient sign flipping, where W is the same as in FIG. 6; and

FIG. 9 shows a block diagram illustrating an architecture of a system according to embodiments of the present invention.

### DETAILED DESCRIPTION OF THE INVENTION

In the following description, systems and methods for preventing gradient-based watermark removal from outputs of deep image generation models and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

An overlooked vulnerability is identified in the watermark decoder, which, when jointly trained with the encoder, can be exploited to train a watermark removal network. To counter such attacks, in the present invention, a Decoder Gradient Shield (DGS) is introduced as a protection layer within the decoder API, designed to prevent gradient-based watermark removal through a closed-form solution. The underlying concept draws inspiration from classical adversarial attack techniques, but is applied herein for the first time as a defensive mechanism in the context of box-free model watermarking. The DGS mechanism reorients and rescales the gradient directions of watermarked queries, thereby preventing the training loss of the watermark removal network from converging to its baseline level in the absence of DGS, while preserving the visual fidelity of the decoder output. Experimental evaluations confirm the effectiveness of the proposed approach.

To make the solution provided by the present invention more understandable, the related information is provided.

### 1) Related Information

### 1.1) Model Extraction

Model extraction, also known as model stealing or surrogate attack, aims to replicate a victim model's functionality, in which the attacker curates a set of query data, and with the victim model returned query outputs, trains a surrogate model. Previous research mainly focused on stealing deep classification models, in which the surrogate query data can be public data, evolutionary proxy data, or even synthetic noise, and the attack can be successful even if the victim model only returns hard labels. Model extraction can also be launched against self-supervised image encoder and ensemble models.

### 1.2. Box-FreeWatermarking

Box-free watermarking is so named because the watermark is extracted from the model outputs using a dedicated watermark decoder, not requiring the protected model. The watermark decoder can be: (1) pretrained and frozen when fine-tuning the protected model for watermark embedding; (2) jointly trained with the protected model; or (3) a post-hoc model not coupled with the protected model. Since the watermarks are embedded in the protected model outputs, box-free methods are commonly applied to generative models with high entropic image outputs.

### 1.3. Watermark Removal

Watermark removal in the context of box-free watermarking is similar yet different from the conventional image watermarking. Through the alteration of victim model returned outputs before surrogate training, the removal attack aims to ensure that the watermark cannot be extracted from surrogate model generated images. Such alteration can be either normal image augmentation or a specially designed process such as inpainting or an image-to-image watermark remover. These removers are also constrained to preserve the image quality for effective surrogate training.

### 1.4. Gradient Attack and Defense

The attack on neural network gradient has been researched for a decade and is mainly for generating adversarial examples. It can be a white-box attack such as the classic fast gradient sign method (FGSM) and projected gradient descent (PGD). Under the more practical black-box setting, the gradient to be attacked can be estimated via querying, while the required query times can be substantially reduced. These results serve as the foundation of the proposed threat model assuming observable gradients of the black-box decoder to the attacker. In model watermarking, gradient alteration has instead been utilized as a defense approach to protect the extraction of classification models, but it cannot withstand hard-label based extraction. It is noted that the provided solution of the present invention is the first to incorporate gradient alteration in protecting image-to-image models.

### 2. Problem Formulation

### 2.1. Box-free Model Watermarking

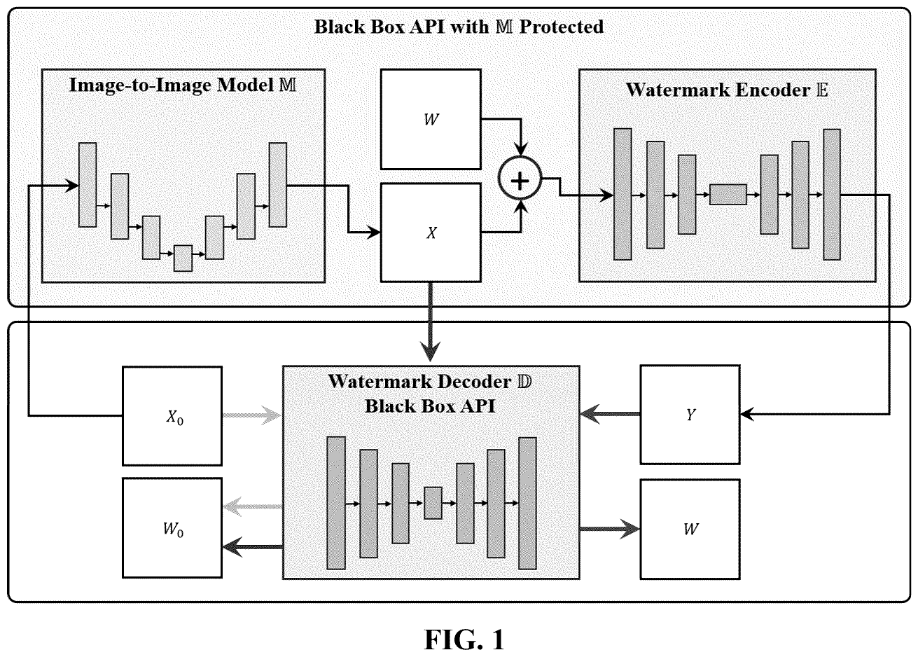

Since all box-free watermarking methods share the same extraction process using [symbol] , without loss of generality, it is considered the post-hoc type as a target watermarking model, whose workflow is depicted in FIG. 1. The watermarking model contains:
Image Processing: X≙ [symbol] (X₀),
Watermark Embedding: Y≙ [symbol] (Concat (X,W)),
Watermark Extraction: [symbol] : [symbol] →W and [symbol] ^{C}→W₀,
where Concat(⋅) denotes the channel-wise concatenation and [symbol] ₀, [symbol] ⊂ [symbol] ^{C}.
   With [symbol] untouched, [symbol] and [symbol] are jointly trained by minimizing

$${ℒ}_{Victim} = {α}_{1} {ℒ}_{Embed} + {α}_{2} {ℒ}_{Fidelity} , \qquad ( 1 )$$

where α₁ and α₂ are weighting parameters,

$${ℒ}_{E m b e d} = {\sum }_{Y ∈ 𝒴} {‖ 𝔻 ( Y ) - W ‖}_{2}^{2} + {\sum }_{S ∈ {𝒴}^{C}} {‖ 𝔻 ( S ) - {W}_{0} ‖}_{2}^{2} , \qquad ( 2 )$$

$${ℒ}_{F i d e l i t y} = {\sum }_{Y ∈ 𝒴 , X ∈ 𝒳} {‖ Y - X ‖}_{2}^{2} , \qquad ( 3 )$$

and S denotes an arbitrary image. Note that [symbol] is indirectly expressed by its output Y in Eq. (2) and Eq. (3), which facilitates the provided subsequent attack formulation in which [symbol] is inaccessible.

### 2.2. Threat Model

Defender. It is considered that the owner of [symbol] as the defender, who not only trains [symbol] but also implements box-free watermarking and owns [symbol] and [symbol] . The defender aims to extract watermarks in surrogate model generated images or prevent surrogate training, i.e., incurring non-negligible performance degradation in surrogate models. As shown in FIG. 1, the defender only provides the black-box API which accepts query X₀ and only returns Y, while [symbol] and [symbol] are strictly private. The black-box API of D is also provided to accept watermark verification queries.

Attacker. On the other side, the attacker aims to extract [symbol] with a watermark-removed surrogate model. To achieve so, the attacker curates a set of X₀ to query the victim model and obtains a set of Y, which is identical to how normal users behave. Then, prior to surrogate training, the attacker alters Y for watermark removal while preserving image quality. Meanwhile, the attacker can query [symbol] to check if an image contains the defender-embedded watermark. In addition, it is assumed that the attacker can observe the gradient backpropagated from the output of [symbol] , thanks to the adversarial attack literature. Furthermore, if the watermark remains intact despite attempts by a removal-loss-minimized remover, the attacker might reasonably infer the presence of defender-imposed gradient perturbations and adjust the returned gradient as a countermeasure.

### 2.3. Gradient-based Removal Attack

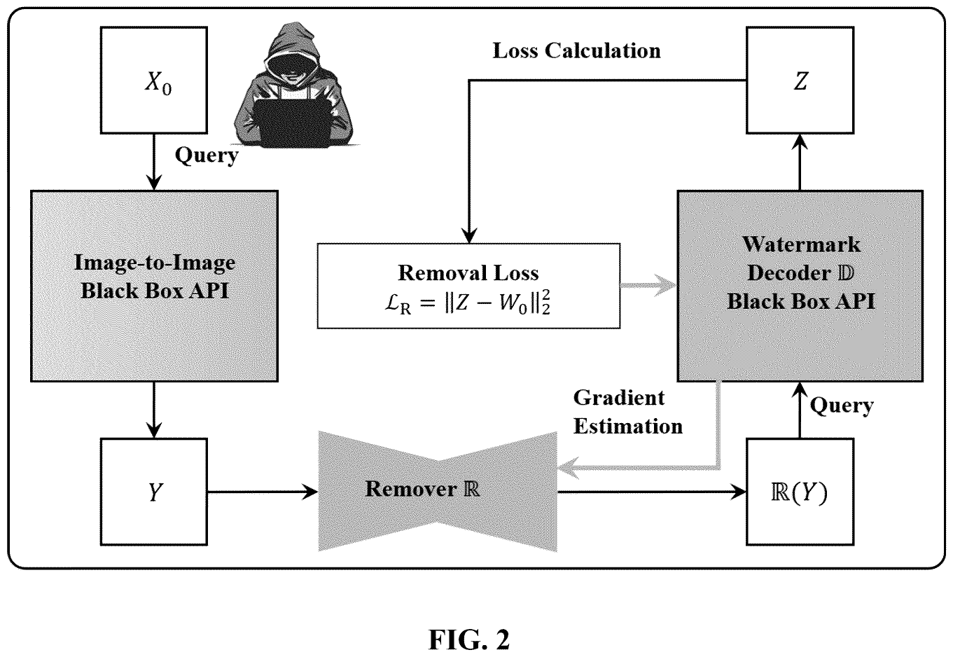

The gradient-based box-free watermark removal attack, as illustrated in FIG. 2, is formulated as follows. The rationale behind is that the attacker can deploy an inverse of [symbol] , i.e., another image-to-image network [symbol] , which takes in Y and undoes watermark embedding. This can be achieved by using [symbol] as a watermark verifier and an all-white null watermark W₀ as the supervision signal, leading to the minimization problem with the loss function:

$${ℒ}_{Attack} = {β}_{1} {ℒ}_{Removal} + {β}_{2} {ℒ}_{F i d e l i t y}^{A} , \qquad ( 4 )$$

where β₁ and β₂ are the weighting parameters,

$${ℒ}_{Removal} = {‖ 𝔻 [ ℝ ( Y ) ] - {w}_{0} ‖}_{2}^{2} , \qquad ( 5 )$$

$${ℒ}_{F i d e l i t y}^{A} = {‖ ℝ ( Y ) - Y ‖}_{2}^{2} . \qquad ( 6 )$$

The removal loss ensures that the altered Y, i.e., [symbol] (Y), does not contain the watermark, while the fidelity loss ensures the preserved image quality for subsequent surrogate training. To minimize Eq. (5), it holds that:

$$∇ {ℒ}_{Removal} ∝ \frac{\partial {ℒ}_{Removal}}{\partial 𝔻 [ ℝ ( Y ) ]} \frac{\partial 𝔻 [ ℝ ( Y ) ]}{\partial ℝ ( Y )} , \qquad ( 7 )$$

where ∇ [symbol] _{Removal} is the gradient component backpropagated to update [symbol] parameters. The [symbol] ₂-norm loss function is used in Eq. (5) in the present disclosure, although other loss functions can also be possible. Under the provided threat model, the gradient of [symbol] in Eq. (7), ∂ [symbol] [ [symbol] (Y)]∂ [symbol] (Y), is observable, and all other gradient components are determined (known) by the attacker. Therefore, [symbol] can be effectively trained in the black-box setting.

It is noted that the above attack resembles the classical adaptive filter for model inversion where [symbol] is the inverse of [symbol] . Given the black-box access of [symbol] and without protection, this attack has a theoretical guarantee of convergence.

### 3. The Proposed Decoder Gradient Shield

The black-box setting of [symbol] enables the defender to alter its output before returning to the user for protection purposes, while the alteration is subject to the constraint of not affecting the watermark extraction functionality. This is similar to API poisoning based defense for black-box (backdoor) watermarking, but it is formulated herein for box-free watermarking. The proposed DGS is derived as follows.

### 3.1. Gradient Reorientation

For the ease of presentation, let Z≙ [symbol] [ [symbol] (Y)] (see FIG. 2) and let Z* be the altered output that is returned to the user. According to Eq. (5) and Eq. (7), the following expression holds:

$$∇ {ℒ}_{Removal} ∝ \frac{\partial {ℒ}_{Removal}}{\partial ℝ ( Y )} = 2 {( Z - {W}_{0} )}^{T} \frac{\partial Z}{\partial ℝ ( Y )} , \qquad ( 8 )$$

where {⋅}^{T}T is the transpose operator. The training of [symbol] requires the curation of a set of Y obtained from querying the encapsulated [symbol] and [symbol] using a set of X₀. During the initial training stage, [symbol] is not able to remove the watermark, yielding Z≈W. To prevent Z from eventually converging to W₀, Z is reoriented into Z* when Z≈W, so the true gradient direction can be protected. According to Eq. (8), the perturbed gradient component can be expressed as:

$${( \frac{\partial {ℒ}_{Removal}}{\partial ℝ ( Y )} )}^{*} = 2 {( {Z}^{*} - {W}_{0} )}^{T} \frac{\partial {Z}^{*}}{\partial ℝ ( Y )} , \qquad ( 9 )$$

which can be designed in such a way that the direction change is between 90 and 180 degrees, i.e.,

$${( {Z}^{*} - {W}_{0} )}^{T} \frac{\partial {Z}^{*}}{\partial ℝ ( Y )} = - {( Z - {W}_{0} )}^{T} P \frac{\partial Z}{\partial ℝ ( Y )} ⇒ {( {Z}^{*} - {W}_{0} )}^{T} \frac{\partial {Z}^{*}}{\partial Z} = - {( Z - {W}_{0} )}^{T} P , \qquad ( 10 )$$

where the chain rule is applied to cancel ∂Z/∂ [symbol] (Y) and P is a positive definite matrix. Note that if P is the identity matrix I, then the above reorientation is simply gradient sign flipping (180 degrees). Meanwhile, to preserve the output image quality, it is required that:

$${Z}^{*} \approx W . \qquad ( 11 )$$

Note that Eq. (10) is a first-order differential equation, and the solution for Z* has the following form:

$${Z}^{*} = - P Z + C , \qquad ( 12 )$$

where C is independent of Z. To solve for C, substitute Eq. (12) into Eq. (11), then the formulation becomes:

$$- P Z + C \approx W ⇒ C \approx ( P + I ) W , \qquad ( 13 )$$

and substituting Eq. (13) into Eq. (12) yields:

$${Z}^{*} = - P Z + ( P + I ) W , \qquad ( 14 )$$

where the approximation is replaced by equality for implementation. The gradient reorientation in Eq. (14) is the essential component in the proposed DGS.

### 3.2. DGS Protected Decoder API

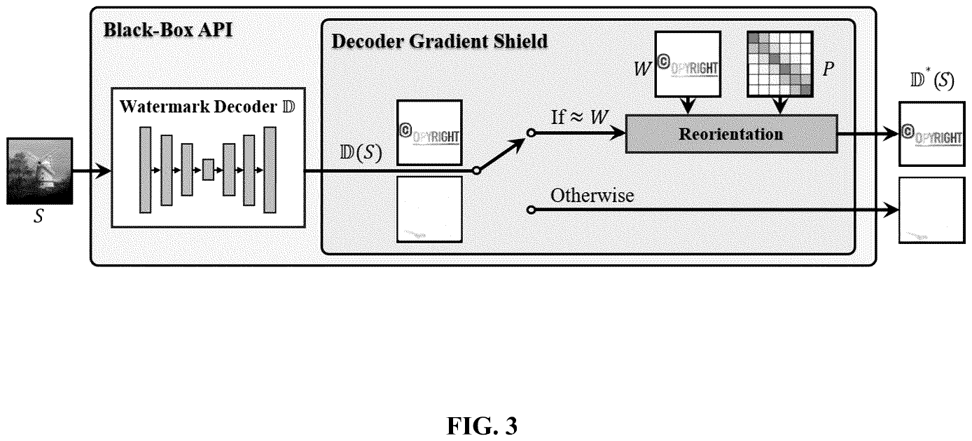

FIG. 3 shows flowchart of the proposed DGS in the black-box API of [symbol] according to some embodiments of the present invention. The incorporation of the proposed gradient reorientation into the API of decoder [symbol] is described as follows. as depicted in FIG. 3. Since [symbol] serves as a black-box watermark verifier to end users, possible situations of the query, denoted by S, without deploying DGS are first discussed below.

Situation 1: S=Y= [symbol] (Concat ( [symbol] (X₀),W))∈ [symbol] . This means that S is a processed and watermarked image from the black-box API of [symbol] and it corresponds to the benign query for watermark extraction. It then follows from Section 2.1 that it returns [symbol] (S)= [symbol] (Y)≈W.

Situation 2: S= [symbol] (Y). This is the malicious query for gradient-based removal attack, but it is indistinguishable from Situation 1 because Eq. (6) ensures that [symbol] (Y) is semantically identical to Y. However, since the true gradient has not been returned for [symbol] to learn watermark removal, the initial malicious query follows that S= [symbol] (Y)∈ [symbol] , and according to Section 3.1, it returns [symbol] (S)= [symbol] [ [symbol] (Y)]=Z≈W.

Situation 3: S∈ [symbol] ^{C}. This corresponds to the benign query with a non-watermarked image, and it follows from Section 2.1 that [symbol] ( [symbol] ^{C})≈W₀ is returned. According to the above situations and incorporating Eq. (14),

The response mechanism of DGS protected [symbol] API, denoted by [symbol] *(S), can be summarized as follows:

$${𝔻}^{*} ( S ) = \{ \begin{matrix}- P 𝔻 ( S ) + ( P + I ) W , & if NC ( 𝔻 ( S ) , W ) > 0.96 , \\ 𝔻 ( S ) , & otherwise\end{matrix} , \qquad ( 15 )$$

where NC(⋅) is the normalized cross-correlation function, and [symbol] (S)≈W is determined using the threshold of 0.96. The above mechanism means that for Situations 1 and 2, since they are indistinguishable, the API returns the gradient reoriented output, while for Situation 3, the API simply returns the original output. Note that the gradient reorientation in Eq. (15) only adds imperceptible perturbations on the extracted watermark W, which does not affect the watermark verification, so its influence on normal users is negligible. However, such perturbation can effectively prevent the attacker from training [symbol] for watermark removal.

It is noted that Eq. (15) is the first solution to protect the decoder [symbol] in box-free watermarking so as to prevent black-box model extraction. It is also a neat closed-form solution compared to gradient-based defense in other contexts, e.g., the recursive methods called prediction poisoning and gradient redirection, for protecting deep classification models.

### 3.3. Choice of P

The positive definite matrix P introduced in Eq. (10) is an essential component in the proposed reorientation process. The risk of omitting P, or equivalently setting P=I, is that the attacker can simply flip the gradient sign back to obtain the true gradient. In the situation where P≠I, let the eigen decomposition be P=Q^{T}ΛQ, where Λ is the diagonal eigenvalue matrix and Q the eigenvector orthonormal matrix, then for a vector multiplied at its right-hand side, it first rotates the vector via Q, followed by scaling the vector elements by the eigenvalues in Λ and finally reverting the rotation via Q^{T}. The rotation imposed by Q is compensated in this process, but the rotation indirectly caused by scaling using Λ is not. For example, as just one use case, it is considered that Q=I and thus P=Λ is a diagonal matrix with all-positive elements. As long as these elements are unequal, −P in Eq. (10) can incur a 90 to 180 degrees rotation. Note that the attacker can still flip the gradient sign, while this will result in a gradient deviated by 0 to 90 degrees. To further prevent the learning of [symbol] , the gradient norm can be reduced by setting 0<Λ<<1, where Λ is the i-th diagonal element, so that even the attacker succeeds in recovering the true gradient direction, the rate of learning becomes negligibly small.

### 4. Experimental Results

In this section, the experimental results are presented to verify the effectiveness of the proposed DGS. The state-of-the-art box-free watermarking model is selected to implement the proposed defense. Notably, this watermarking model is an extended version for addressing the vulnerabilities of the watermarking scheme to image augmentation attacks, while both share the same watermark encoder and decoder.

### 4.1. Experimental Setting

### 4.1.1. Datasets

It is considered that two representative image-to-image tasks, i.e., image deraining (classic low-level image processing) and style transfer (a high-level computer vision task). For both tasks, the PASCAL VOC dataset with different data splits is used. For image deraining, the data corresponds to X in FIG. 1. The 12,000 training images are uniformly split into two equal parts, each containing 6,000 for victim model training and remover training, respectively. Rainy images corresponding to X₀ in FIG. 1 are generated using the desired algorithm. For style transfer, the PASCAL VOC data are treated as X₀ and similarly divided for victim and remover training. The style transfer algorithm is employed to generate X. Additionally, to reduce the computational complexity, all images are resized to 256×256 grayscale.

### 4.1.2. Metric

For fidelity evaluation, peak signal-to-noise ratio (PSNR) and multi-scale structural similarity index (MSSSIM) are used to measure the similarity between two images. For robustness evaluation, the success rate of defense is used, denoted by SR, which is the ratio of the number of images with embedded watermarks successfully extracted over the total number of watermarked images under going through removal attacks.

### 4.1.3. Implementation Detail

The model architecture, hyperparameters, and training process used for the victim model are based on commonly adopted configurations, including components [symbol] and [symbol] . The gradient-based remover [symbol] is implemented using a UNet architecture. Both models are trained from scratch for 100 epochs using the Adam optimizer with a learning rate of 0.0002. Weighting parameters α₁, α₂, β₁, and β₂ in Eq. (1) and Eq. (4) are set equally to 1.

### 4.2. Convergence of Removal Loss

The effectiveness of the proposed DGS is first verified in terms of its ability to prevent [symbol] from learning to remove the watermark, as reflected in the loss behavior observed during the training of [symbol] . Due to DGS, the actual removal loss obtained by the attacker is modified from Eq. (5) to:

$${ℒ}_{Removal}^{A *} = {‖ {Z}^{*} - {W}_{0} ‖}_{2}^{2} \qquad ( 16 )$$

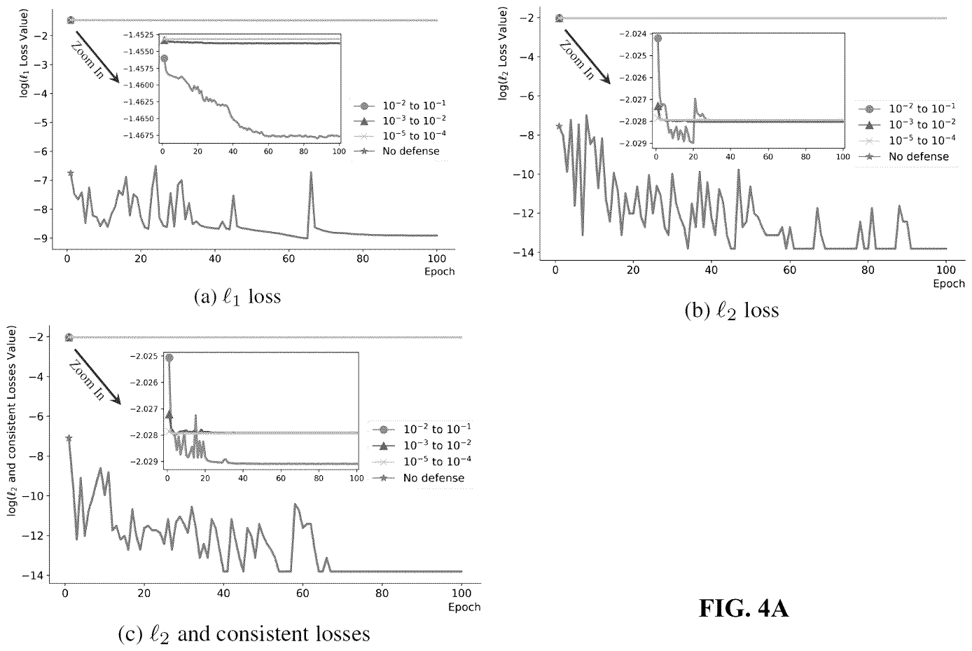

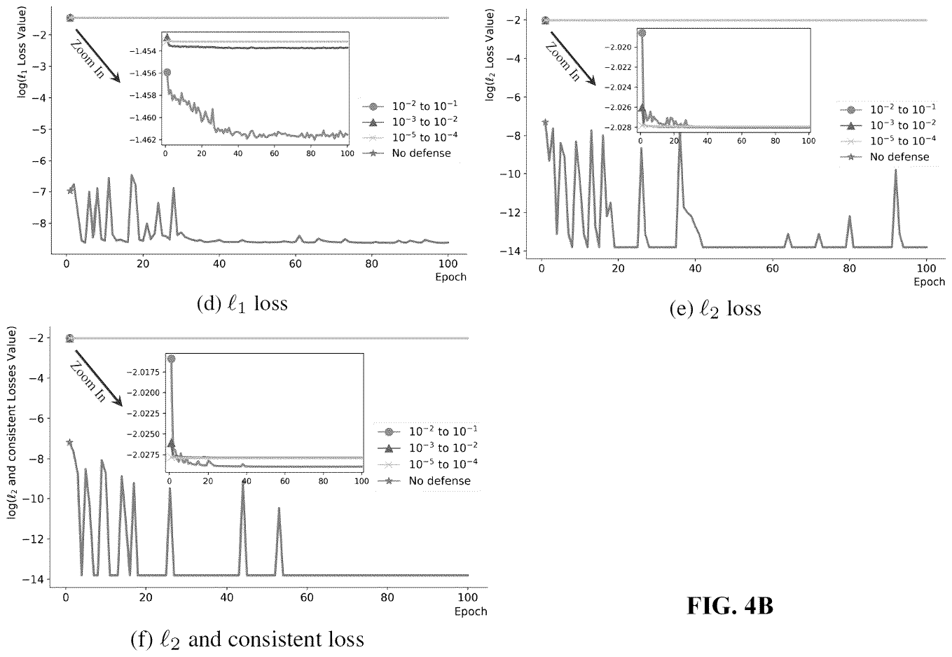

when the [symbol] ₂-norm is used. It is worth noting that the proposed DGS is derived based on the [symbol] ₂-norm removal loss function. In fact, the attacker can use other removal loss functions, such as the [symbol] ₁-norm and [symbol] ₂-norm plus consistent loss. This reflects the real-world situation of removal loss mismatch, which is also considered in the provided experiments, while the fidelity loss is consistently the [symbol] ₂-norm in Eq. (6). The results for deraining and style transfer tasks are presented in the first and second rows, respectively, in FIG. 4A and FIG. 4B.

FIG. 4A and FIG. 4B show demonstration of the convergence behavior of attacker's removal loss functions when training [symbol] , under different choices of P. The 1 st row is deraining and the 2nd row is style transfer. The [symbol] ₁ loss is

$${‖ {Z}^{*} - {W}_{0} ‖}_{1}^{2} ,$$

the [symbol] ₂ loss is

$${‖ {Z}^{*} - {W}_{0} ‖}_{2}^{2} ,$$

while the consistent loss is incorporated from other work. The loss corresponding to no defense is

$${‖ Z - {W}_{0} ‖}_{2}^{2} .$$

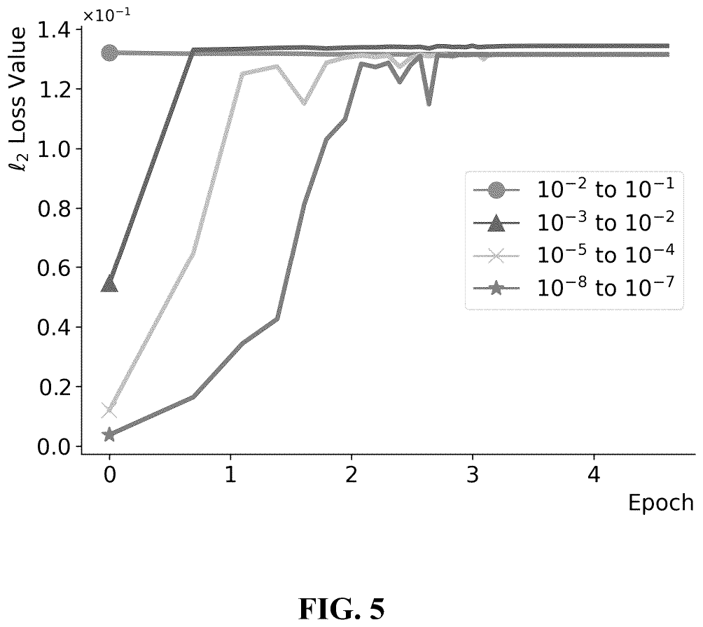

For both tasks, when no defense is deployed, all loss values converge to the zero level, 10⁻⁸ and 10⁻¹⁴, respectively, which verifies the effectiveness of the gradient-based removal attack. It is also observed that the use of the consistent loss leads to a smoother convergence curve. In contrast, with DGS deployed, none of the loss functions can be reduced. It can be seen from the zoom-in versions that all the loss values show a decreasing trend but in a negligibly small range, indicating the successful prevention of [symbol] from learning to remove the watermark. The results also verify that the proposed defense based on the [symbol] ₂-norm removal loss can be well generalized against other loss functions. To further verify the ineffectiveness of the training of [symbol] , the loss between the raw output of [symbol] , i.e., Z, and W₀ is presented when [symbol] is trained in presence of DGS, and the results are shown in FIG. 5, where deraining is considered as an example. FIG. 5 shows demonstration of the convergence behavior of the true loss function

$${‖ Z - {W}_{0} ‖}_{2}^{2}$$

after deploying the proposed DGS, under different choices of P, and deraining is considered as an example. It can be seen that for all choices of P, the loss values increase and converge to a high level corresponding to failure of watermark removal.

### 4.3. Effectiveness

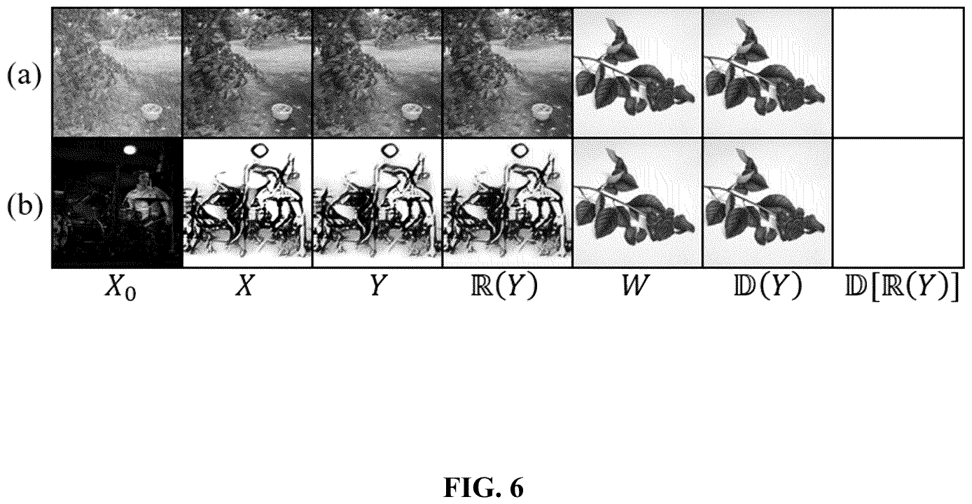

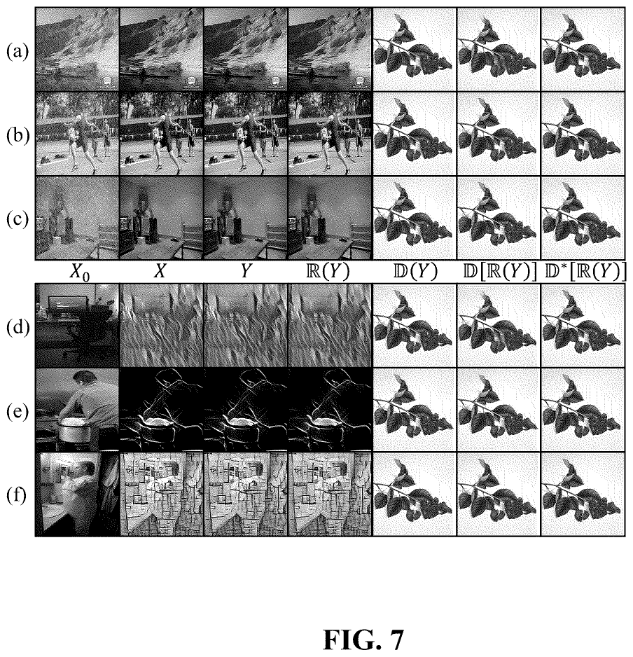

Illustrative image and watermark examples for both deraining and style transfer tasks before and after the proposed DGS are presented in FIG. 6 and FIG. 7, respectively. FIG. 6 shows demonstration of the gradient-based watermark removal attack without defense, in which Part (a) is Deraining and Part (b) is Style transfer. FIG. 7 shows demonstration of the gradient-based watermark removal attack with the proposed DGS defense, where Part (a) to Part (c) are deraining, Part (d) to Part (f) are style transfer, and W is the same as in FIG. 6. The removal loss functions used by the attacker are [symbol] ₁ loss in Part (a) and Part (d), [symbol] ₂ loss in Part (b) and Part (e), and [symbol] ₂ plus consistent in Part (c) and Part (f).

The images from left to right are the to-be-processed X₀, processed non-watermarked X, processed and watermarked Y, watermarked attacked by remover [symbol] (Y), original watermark W, decoded watermark without attack [symbol] (Y), decoded watermark after attack [symbol] [ [symbol] ] (Y) (or equivalently Z), and DGS perturbed result [symbol] * [ [symbol] ] (Y) (or equivalently Z*). It can be observed that without defense, the gradient-based attack successfully removes the watermark from Y in both tasks, leading to nearly all-white images at the output of [symbol] . In contrast, with the proposed DGS, the attacker cannot remove the watermark, not only with matched loss (Part (b) and Part (e) in FIG. 7) but also with mismatched losses (other subfigures in FIG. 7). Additionally, comparing the last two columns, DGS preserves decoder output image quality with imperceptible difference between [symbol] [ [symbol] (Y)] and [symbol] * [ [symbol] (Y)], allowing legitimate queries while preventing the training of [symbol] .

### 4.4. Robustness

Despite that the perturbed output [symbol] * [ [symbol] (Y)] is returned, the attacker has the freedom to further process it before using it to update R parameters with the hope of rendering potential defenses ineffective. Here, it is considered that three types of further processing imposed by an attacker:
JPEG compression and noise addition.
Lattice attack.
Gradient sign flipping.

Among them, JPEG compression and noise addition (using i.i.d. white Gaussian noise) are intuitive image quality degradation operations, the lattice attack replaces pixels by random values according to a fixed step for watermark removal, while gradient sign flipping can be launched if the attacker observes no reduction of the removal loss and thus believe that the gradient has been flipped. Results for the first two attacks are presented in Tables 1-3, where PSNR and MS-SSIM are used to measure the similarity between the API returned gradient-reoriented output [symbol] * [ [symbol] (Y)] and the attacked version.

TABLE 1
Robustness test of DGS against JPEG compression, where 10⁻⁵ < Λᵢ <
10⁻⁴, PSNR is in dB, and 0 ≤ MS-SSIM, SR ≤ 1.

| | Deraining | | | Style Transfer | | |
|---|---|---|---|---|---|---|
| Factor | PSNR↑ | MS-SSIM↑ | SR↑ | PSNR↑ | MS-SSIM↑ | SR↑ |
| 10% | 28.5748 | 0.9672 | 1.00 | 28.5776 | 0.9673 | 1.00 |
| 20% | 30.8380 | 0.9855 | 1.00 | 30.8364 | 0.9855 | 1.00 |
| 30% | 32.0850 | 0.9902 | 1.00 | 32.0845 | 0.9902 | 1.00 |
| 40% | 33.0321 | 0.9927 | 1.00 | 33.0278 | 0.9927 | 1.00 |

TABLE 2
Robustness test of DGS against WGN addition, where 10⁻⁵ <
Λᵢ < 10⁻⁴, noise level and PSNR are in dB, and 0 ≤ MS-SSIM, SR ≤ 1.

| Noise | Deraining | | | Style Transfer | | |
|---|---|---|---|---|---|---|
| Level | PSNR↑ | MS-SSIM↑ | SR↑ | PSNR↑ | MS-SSIM↑ | SR↑ |
| 0 | 1.7791 | 0.3042 | 1.00 | 1.7768 | 0.3041 | 1.00 |
| 10 | 11.7799 | 0.5613 | 1.00 | 11.7809 | 0.5612 | 1.00 |
| 20 | 21.7774 | 0.8022 | 1.00 | 21.7801 | 0.8022 | 1.00 |
| 30 | 31.7781 | 0.9573 | 1.00 | 31.7784 | 0.9573 | 1.00 |

TABLE 3
Robustness test of DGS against lattice attack, where 10⁻⁵ < Λᵢ <
10⁻⁴, PSNR is in dB, and 0 < MS-SSIM, SR < 1.

| | Deraining | | | Style Transfer | | |
|---|---|---|---|---|---|---|
| Step | PSNR↑ | MS-SSIM↑ | SR↑ | PSNR↑ | MS-SSIM↑ | SR↑ |
| 2 | 12.3766 | 0.6391 | 1.00 | 12.3766 | 0.6391 | 1.00 |
| 6 | 21.9368 | 0.8275 | 1.00 | 21.9370 | 0.8275 | 1.00 |
| 11 | 26.8371 | 0.9263 | 1.00 | 26.8373 | 0.9263 | 1.00 |
| 16 | 30.6777 | 0.9655 | 1.00 | 30.6777 | 0.9655 | 1.00 |

It can be seen that even with a JPEG compression factor of 10% or a lattice attack that randomly alters every 1 out of 3 pixels (step is 2), the success rate of watermark extraction is still 100%. Guaranteed success is preserved with 10 dB noise addition, while the rate reduces to 58% under 0 dB noise for style transfer only, and this is with substantial image quality degradation. Generally, the proposed DGS demonstrates promising robustness against both normal and advanced attacks. To provide more insights, let F be a generic additive interference resulted from the attacker's further operation, and F is independent of Z, then Eq. (14) is modified to:

$${Z}_{Interf}^{*} = - PZ + ( P + I ) W + F , \qquad ( 17 )$$

and the attacker's gradient component is modified from Eq. (9) to:

$$2 {( {Z}_{Interf}^{*} - {W}_{0} )}^{T} \frac{\partial {Z}_{Interf}^{*}}{\partial ℝ ( Y )} = - {2 [ Z - ( {W}_{0} - F ) ]}^{T} P \frac{\partial Z}{\partial ℝ ( Y )} , \qquad ( 18 )$$

This means that with the deployment of DGS, the additive interference forces the remover output to diverge from W₀−F instead of diverging from the original W₀, which still cannot undermine the defense. Additionally, similar performance between deraining and style transfer tasks indicates that DGS is insensitive to data distribution and can be generalized to other image-to-image tasks.

For gradient sign flipping, the reorientation can be partially compensated, not fully, because it is not strictly 90 degrees. Due to this, the attacker-flipped gradient will contain the true gradient component and enable [symbol] to learn watermark removal, though not most efficiently. However, the proposed small values of Λᵢ can effectively reduce the learning rate.

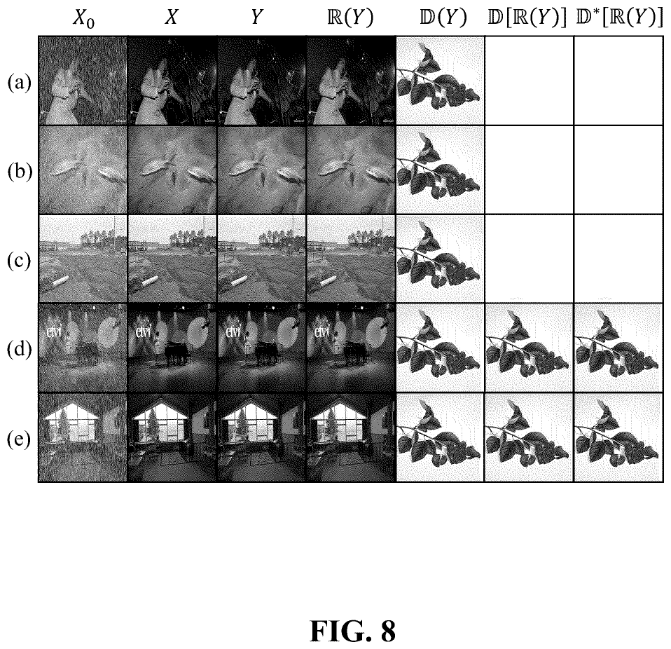

This is illustrated in FIG. 8. FIG. 8 shows demonstration of the robustness of the proposed DGS when the attacker applies gradient sign flipping, where W is the same as in FIG. 6. Deraining is used as an example, and Λᵢ is randomly sampled within Part (a) [10⁻⁴, 10⁻³], Part (b) [10⁻⁵, 10⁻⁴], Part (c) [10⁻⁶, 10⁻⁵], Part (d) [10⁻⁷, 10⁻⁶], and Part (e) [10⁻⁸, 10⁻⁷]. It can be seen that when Λᵢ is within the interval [10⁻⁷, 10⁻⁶] or smaller, DGS remains robust to gradient-based removal attacks.

### 4.5. Limitation

The attacker's intuitive and practical countermeasure of flipping the gradient sign before updating the parameters of [symbol] , in cases where the removal loss cannot be reduced, has been discussed and evaluated experimentally. It is shown that the proposed DGS can still withstand such gradient flipping thanks to the small diagonal values of P, while here a further discussion about the potential weakness of DGS is provided.

According to Eq. (14), the attacker can fully overcome DGS if the hidden Z can be recovered from the observed Z*. To achieve so, the inverse of Eq. (14) is given by:

$$Z = - {P}^{- 1} {Z}^{*} + ( I + {P}^{- 1} ) W , \qquad ( 19 )$$

requiring the knowledge of W and P. While W can be estimated by querying [symbol] using a watermarked image Y∈ [symbol] , it is difficult to guess P. However, the attacker may simply set P=I and replace W by [symbol] *(Y) in Eq. (19), which yields an estimate of Z given by \tilde{Z}=−Z*+2 [symbol] * (Y). According to the provided experiments, such an approximation suffers from performance degradation, but it remains open for the attacker to develop more advanced attacks to improve the estimation of Z. It is noted that the existing gradient-based defense methods are also vulnerable to gradient sign flipping, indicating that incurring a gradient rotation between 90 to 180 degrees may not be sufficient for protection.

Based on the foregoing technical architecture and associated verification workflow, the present disclosure provides a concrete hardware system configured to perform watermark-protected output generation and secure verification in deep image generation models. The system comprises interconnected software and hardware modules that execute data processing operations on content or image outputs produced by deep neural networks. These operations include applying trained watermark decoders, introducing controlled interference to gradient signals, and preserving image fidelity during verification. The implementation requires computer-implemented components due to the high dimensionality of the image data, the complexity of neural network transformations, and the nature of gradient-sensitive attack vectors. Accordingly, the claimed system is rooted in computer technology and provides a practical application in protecting ownership of AI-generated visual content, particularly in scenarios where the generation model is accessed only through black-box APIs.

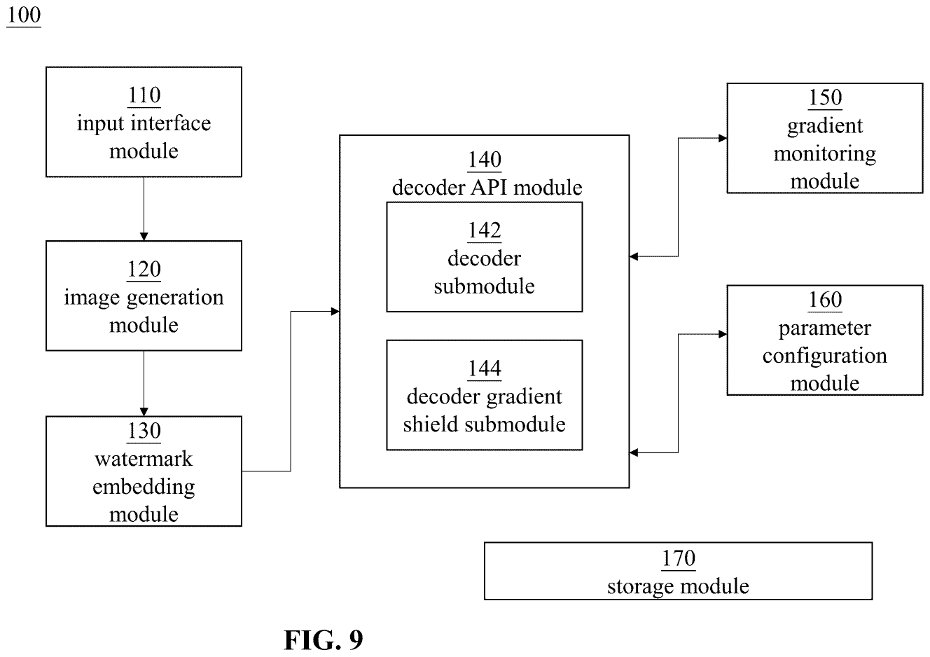

FIG. 9 shows a block diagram illustrating an architecture of a system 100 according to embodiments of the present invention. A system 100 includes a set of modules that operate together to (1): accept external image inputs; (2): generate image outputs embedded with ownership-identifying watermarks; and (3): prevent adversarial models from learning to remove said watermarks by modifying internal decoder behaviors. The system 100 is especially suited for use in applications involving deep image generation models such as style transfer, denoising, inpainting, and super-resolution. In this regard, the system 100 is not designed merely as an external plugin or wrapper, but rather as an integrated solution in which the image generation model itself is a core component. The protection mechanisms described herein are tightly coupled with the model's output processing pipeline to achieve seamless embedding and secure verification of watermark content.

The system 100 includes an input interface module 110, an image generation module 120, a watermark embedding module 130, a decoder API module 140 with a decoder submodule 142 and a decoder gradient shield submodule 144, a gradient monitoring module 150, a parameter configuration module 160, and a storage module 170. The modules and components of system 100 may communicate with one another via wired or wireless connections and may operate in a coordinated manner under the control of a processor configured to manage the execution flow, data transfer, and functional cooperation among the modules.

The input interface module 110 is configured to receive input data from external sources, including user-provided content or data samples. Such inputs may include image files in standard formats (e.g., JPEG, PNG, BMP), text prompts, or other structured query types compatible with the image generation model. These inputs may be transmitted through an application programming interface (API) or a user-facing graphical interface. The input interface module 110 prepares the received data for subsequent internal processing by validating the input type, normalizing its format, and forwarding it to the image generation module 120 for content generation.

The image generation module 120 is configured to apply a deep generation model to transform the input from the input interface module 110 into a processed version. The applied deep generation model may follow an encoder-decoder architecture or transformer-based structure, and performs tasks such as style adaptation, noise reduction, content synthesis, or texture enhancement. The decoder portion of the deep generation model produces a high-entropy output image which retains essential visual features from the input. The parameters of the applied deep generation model are fixed during deployment to prevent exposure of internal mechanisms. The image generation module 120 receives normalized data from the input interface module 110 and processes it through the deep generation model. Upon transformation, the image generation module 120 outputs a model-generated image that preserves structural or semantic attributes of the input, and passes this image to the watermark embedding module 130 for further processing.

The watermark embedding module 130 is configured to embed a non-visible ownership watermark into the output image produced by the deep generation model of the image generation module 120. This is accomplished by integrating a predefined watermark pattern with the high-entropy output image through a channel-wise or frequency-domain embedding process. The embedding operation is performed after the final decoder layer of the generation model and does not alter the model weights. The resulting watermarked image is perceptually similar to the original output while enabling ownership verification through a decoder mechanism. After embedding the watermark, the watermark embedding module 130 outputs a watermarked image, which may be transmitted externally or held for verification through the decoder API module 140.

The decoder API module 140 is configured to verify the presence of a non-visible ownership watermark in a received query image. The decoder API module 140 serves as the interface for watermark verification and is accessible via black-box API calls. The decoder API module 140 receives query images, which may include the watermarked image output from the watermark embedding module 130 or an externally manipulated version of such output. The decoder API module 140 includes a decoder submodule 142 and a decoder gradient shield submodule 144. Upon receiving a query image, the decoder API module 140 passes the image to the decoder submodule 142 for watermark extraction and, under certain conditions, to the decoder gradient shield submodule 144 for protection against adversarial behavior.

The decoder submodule 142 is configured to extract an embedded watermark from a query image received through the decoder API module 140. This decoder submodule 142 applies a trained decoder network to identify and reconstruct the embedded watermark pattern. The decoder network of the decoder submodule 142 is specifically trained on the watermarked images produced by the deep generation model of the image generation module 120 and embedded by the watermark embedding module 130. This targeted training enables the decoder submodule 142 to identify watermark signals that persist despite transformations introduced by the deep generation process.

The decoder gradient shield submodule 144 is configured to defend against gradient-based watermark removal attacks. Under conditions indicative of adversarial querying, such as repeated queries with minimal image variation, abnormally low entropy, or statistical patterns resembling known attack strategies, the decoder gradient shield submodule 144 introduces controlled perturbations into the watermark extraction response. These perturbations may include reorientation of gradient directions, suppression of loss signal convergence, or transformation of intermediate decoding activations, such that any gradients computed by an adversarial model during backpropagation become ineffective for training a watermark remover.

In some embodiments, to avoid disrupting normal verification behavior, the perturbation process is selectively activated based on contextual query analysis. When protection is active, the decoder gradient shield submodule 144 maintains perceptual consistency of the watermark output for human-readable inspection and standard matching procedures, while injecting sufficient variation to undermine gradient fidelity. The perturbation routines can be dynamically adjusted in strength or direction based on configuration inputs, and are implemented in a closed-form logic that is computationally efficient and compatible with real-time deployment constraints.

In some embodiments, the decoder gradient shield submodule 144 may receive operational parameters, including response thresholds and perturbation patterns, from the parameter configuration module 160 and may be selectively activated based on input from the gradient monitoring module 150. Additionally, this submodule may produce internal response logs or diagnostic flags to aid in post-analysis of suspected attacks or to adaptively update protection strategies during runtime.

More specifically, in the case of non-watermarked queries, the decoder submodule 142 may return a null watermark output, such as an all-white image or a predefined neutral pattern, representing the absence of embedded watermark information. In contrast, for watermarked queries, the decoder gradient shield submodule 144 is configured to apply controlled perturbations directly to the decoder output generated by the decoder submodule 142. These perturbations are applied by modifying one or more pixel values, numerical arrays, or activation outputs in a manner that alters the gradient direction and/or magnitude when the decoder output is used as a supervisory signal in a backpropagation process. For example, the perturbations may include applying a matrix transformation that introduces directional offsets or scaling factors to the decoded watermark output, without materially affecting its human-perceptible appearance. The purpose of such perturbations is to degrade the utility of the decoder output for computing reliable gradients in gradient-based training. In particular, these perturbations prevent the loss signal used in watermark removal network training from converging to a minimum, thereby inhibiting successful optimization. The transformation parameters may be predetermined or dynamically selected from a configuration source such as the parameter configuration module 160. The perturbation process is selectively applied only to query inputs that match a set of predefined adversarial criteria.

As used herein, the term “perturbation” refers to any algorithmically generated modification to the output values of the decoder submodule 142 that is not readily detectable by human inspection, but causes a deviation in gradient computation when subjected to automatic differentiation or backpropagation procedures in a learning-based model.

The gradient monitoring module 150 is configured to monitor input patterns and decoder outputs over time to detect signs of model extraction behavior. The gradient monitoring module 150 maintains a session history and evaluates characteristics such as repetitive query structure, abnormal verification variance, and statistical similarity to known attack strategies. Upon detection of such patterns, the gradient monitoring module 150 may trigger or modulate protection strategies executed by the decoder gradient shield submodule 144. This interaction allows the system 100 to dynamically adapt to potentially adversarial activity while maintaining normal verification functions.

The parameter configuration module 160 is configured to manage and supply control parameters that govern the behavior of the decoder gradient shield submodule 144. These parameters include transformation thresholds, perturbation strength levels, decision criteria for activation, and reference watermark patterns used during protected verification. The parameter configuration module 160 may maintain multiple configuration profiles to adapt to different deployment environments or threat conditions.

In addition to supplying decoder gradient shield submodule 144 with operational parameters such as perturbation strength, pattern thresholds, and trigger conditions, the parameter configuration module 160 also provides an administrative interface. This interface enables authorized users or system components to modify watermark payloads, adjust sensitivity thresholds, and update protection rules in response to system usage trends or observed adversarial activity. The parameter configuration module 160 may interact periodically with storage module 170 to retrieve or store configuration records as part of long-term protection strategy management.

The storage module 170 is configured to manage persistent storage of critical system resources used by various functional modules. These resources include trained model weights required by the image generation module 120, decoder logic parameters used by the decoder submodule 142, and watermark reference patterns accessed by both the watermark embedding module 130 and the parameter configuration module 160. In some embodiments, the storage module 170 may also maintain training data samples, system configuration records, and logs of API queries for forensic analysis or audit purposes. In some embodiments, the storage module 170 may interact with the gradient monitoring module 150 by supplying historical query logs or decoder response records to support detection of suspicious patterns over time. In some embodiments, the storage module 170 may serve as a centralized repository for configuration snapshots or runtime update packages used by the parameter configuration module 160 to manage protection strategies. In some embodiments, the storage module 170 may further provide reference watermark datasets to the decoder submodule 142 to facilitate reliable verification during watermark extraction operations.

In one embodiment, the system 100 performs watermark-protected image generation and secure verification through a coordinated series of module interactions.

The process begins when a user provides input data to the input interface module 110. This input may take the form of an image file, a text prompt, or a structured query format compatible with the deep generation model. The input interface module 110 validates the format and content of the received data, normalizes it into an acceptable internal representation, and forwards the resulting input to the image generation module 120.

Upon receiving the normalized input, the image generation module 120 applies a deep generation model, such as an encoder-decoder network or transformer-based model, to generate a synthesized output image. The generated image maintains the semantic or structural content specified in the user input. The output of the deep generation model is passed directly to the watermark embedding module 130.

The watermark embedding module 130 embeds a non-visible ownership watermark into the generated image using a predefined watermark pattern. The embedding process may be performed in the spatial or frequency domain after the final decoder layer of the deep generation model, and does not require modifying any model weights. The resulting watermarked image remains perceptually similar to the unwatermarked output and can either be delivered externally or submitted for verification.

If watermark verification is requested, the watermarked image (whether originating directly from watermark embedding module 130 or received externally) is sent to the decoder API module 140. The decoder API module 140 accepts the image as a query and passes it to the decoder submodule 142 for watermark extraction. The decoder submodule 142 uses a trained decoder network to identify and reconstruct the embedded watermark pattern. This decoder of the decoder submodule 142 is trained specifically on images produced by the deep generation model and watermarked by watermark embedding module 130, allowing it to recognize watermarks even after transformations introduced by generation.

Concurrently, the gradient monitoring module 150 observes query activity and decoder outputs over time. The gradient monitoring module 150 evaluates characteristics such as repeated queries, minimal image variation, and response patterns consistent with model extraction or surrogate training attempts. If adversarial behavior is detected, the gradient monitoring module 150 signals the decoder gradient shield submodule 144 to activate its protection mechanisms.

When activated, the decoder gradient shield submodule 144 applies controlled perturbations to the output of the decoder submodule 142. These perturbations include modifying the decoder output with transformation logic such as directional offset matrices or controlled output scaling. The modifications are constructed to disrupt any backpropagation-based optimization process that would otherwise attempt to learn a watermark removal function, while retaining the visual quality and verification integrity of the decoded watermark output. The protection behavior may be selectively applied to queries classified as potentially adversarial and is governed by parameter settings managed by the parameter configuration module 160.

The parameter configuration module 160 provides operational thresholds, perturbation strengths, reference watermark data, and administrative overrides that control the protection logic of the decoder gradient shield submodule 144. These settings may be dynamically adjusted or selected from predefined profiles.

Throughout the process, the storage module 170 supports system execution by maintaining persistent access to trained model weights for the deep generation model, decoder parameters, watermark references, query logs, and configuration files. The storage module 170 may also support secure access control and provide historical data to support monitoring and auditing tasks by the gradient monitoring module 150 and the parameter configuration module 160.

The following points illustrate the core protection mechanisms enabled by the decoder gradient shield (DGS) within the proposed system.

1. Protection Against Gradient-Based Watermark Removal: DGS serves as a defense mechanism within the watermark decoder, shielding it from gradient-based attacks that aim to remove the watermark from generated images.

2. API Protection for Deep Image Generation Models: By integrating DGS into the decoder's API, it distinguishes between benign and potentially malicious queries. This selective application of gradient reorientation and rescaling maintains normal functionality for legitimate queries while protecting the model against unauthorized attempts to remove the watermark.

The system may be deployed in various practical contexts, including the following application scenarios that benefit from DGS-enabled watermark protection.

1. Intellectual Property Protection and Robust Watermarking for AI Models with Image Output: DGS can be employed by organizations to safeguard the intellectual property of AI models and the unique outputs they generate, especially in applications like image generation, denoising, style transfer, and super-resolution. By embedding robust watermarks into the model's outputs, companies can assert ownership, prevent unauthorized use, and provide proof of originality, thereby protecting both the model and its generated content from misuse or copying.

2. Security for Commercial Machine Learning APIs: DGS is applicable in commercial API services that provide image generation capabilities. By integrating watermark protection directly into the API, companies can control access and usage, preventing unauthorized parties from using gradient-based watermark removal techniques to remove watermarks from output images.

3. Prevention of Model Theft and Unauthorized Use: In scenarios where models are accessible to external users (e.g., via cloud-based platforms), DGS ensures that any outputs generated are watermarked and that the watermark cannot be removed without degrading output quality. This discourages model theft and unauthorized redistribution.

The technical contributions of the proposed system are reflected in the following design features, which improve both the robustness and efficiency of watermark defense.

1. Enhanced Security Against Gradient-Based Attacks: Current watermarking solutions in AI model often lack robust defenses against gradient-based removal attacks and the mechanism to protect watermark decoder. DGS introduces a novel method that reorients and rescales gradients to protect against such attacks.

2. Closed-Form Solution for Efficiency and Robustness: Advanced defenses against watermark removal often rely on computationally intensive iterative methods that slow down model responses and affect user experience, especially in real-time applications. DGS employs a closed-form solution, allowing for efficient gradient alteration without significant computational overhead.

3. Adaptability Across Various Tasks with Image Output: DGS is adaptable across a wide range of tasks with image output, providing flexibility for diverse applications. DGS's matrix-based transformation is configurable, allowing it to be tailored to the specific needs of various models, thus expanding its applicability in AI-powered image and video processing.

As discussed above, existing box-free watermarking methods for image-to-image models typically utilize a dedicated decoder [symbol] for extracting watermark information directly from watermarked images. Because decoder [symbol] is functionally coupled with the protected encoder [symbol] , its exposure through black-box querying renders the watermarking mechanism susceptible to exploitation for watermark removal. Based on this vulnerability, a gradient-based removal attack has been developed and shown capable of removing state-of-the-art box-free watermarks. To mitigate such attacks, a DGS framework has been introduced within the black-box API of decoder [symbol] , along with a corresponding closed-form solution. The DGS framework reorients and rescales the gradient of watermarked queries using a positive definite matrix P. With appropriate eigenvalue selection for matrix P, the learning process of a watermark removal network R can be effectively disrupted. Experimental evaluations have demonstrated the effectiveness of DGS on both image deraining and style transfer tasks. Further research may be conducted to enhance the robustness of DGS against reverse engineering of the true gradient.

The functional units and modules of the systems and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for protecting a watermark embedded in an image output generated by a deep generation model, comprising:
an input interface module configured to receive input data comprising image files, text prompts, structured queries, or combinations thereof, to normalize the input data;
an image generation module configured to apply a deep generation model to the normalized input data received from the input interface module to generate a model-generated image;
a watermark embedding module configured to embed a non-visible ownership watermark into the model-generated image using a predefined watermark pattern to produce a watermarked image;
a decoder API module configured to receive a query image which comprises the watermarked image or a derived version thereof, and to extract a watermark representation from the query image, wherein the decoder API module comprises:
a decoder submodule configured to apply a trained decoder network to extract the watermark representation from the query image; and
a decoder gradient shield submodule configured to apply controlled perturbations to outputs of the decoder submodule under detection of adversarial query behavior, wherein the controlled perturbations modify the outputs of the decoder submodule in a manner that alters gradient direction or magnitude without degrading perceptual watermark quality; and
a gradient monitoring module configured to monitor input patterns and decoder outputs received via the decoder API module, and to signal the decoder gradient shield submodule when query patterns indicative of model extraction attempts are detected.

2. The system of claim 1, further comprising:
a parameter configuration module configured to store and supply operational parameters to the decoder gradient shield submodule based on system conditions; and
a storage module configured to store model weights for the image generation module, decoder parameters for the decoder submodule, watermark reference patterns for the watermark embedding module and parameter configuration module, and query logs used by the gradient monitoring module.

3. The system of claim 1, wherein the input interface module is further configured to validate the format of the input data prior to normalization.

4. The system of claim 1, wherein the watermark embedding module is further configured to perform embedding operation after a final decoder layer of the deep generation model using a channel-wise or frequency-domain process.

5. The system of claim 1, wherein the decoder submodule is trained using watermarked images generated by the image generation module and processed by the watermark embedding module.

6. The system of claim 5, wherein the decoder gradient shield submodule is configured to apply a transformation defined by a positive definite matrix to modify the decoder output.

7. The system of claim 6, wherein eigenvalues of the positive definite matrix are selected to prevent convergence of loss values during training of a watermark removal model.

8. The system of claim 1, wherein the gradient monitoring module is further configured to detect adversarial query patterns based on repetitive structure, abnormal decoder output variance, or statistical similarity to known attack behaviors.

9. A method for protecting a watermark embedded in an image output generated by a deep generation model, comprising:
receiving, by an input interface module, input data comprising image files, text prompts, structured queries, or combinations thereof;
normalizing, by the input interface module, the input data to produce normalized input data;
applying, by an image generation module, a deep generation model to the normalized input data to generate a model-generated image;
embedding, by a watermark embedding module, a non-visible ownership watermark into the model-generated image using a predefined watermark pattern to produce a watermarked image;
receiving, by a decoder API module, a query image comprising the watermarked image or a derived version thereof;
extracting, by a decoder submodule of the decoder API module, a watermark representation from the query image using a trained decoder network; and
applying, by a decoder gradient shield submodule of the decoder API module, controlled perturbations to outputs of the decoder submodule under detection of adversarial query behavior, wherein the controlled perturbations modify the outputs of the decoder submodule in a manner that alters gradient direction or magnitude without degrading perceptual watermark quality.

10. The method of claim 9, further comprising:
monitoring, by a gradient monitoring module, input patterns and decoder outputs received via the decoder API module, and signaling the decoder gradient shield submodule when query patterns indicative of model extraction attempts are detected.

11. The method of claim 9, further comprising:
providing, by a parameter configuration module, operational parameters to the decoder gradient shield submodule based on system conditions.

12. The method of claim 9, further comprising:
storing, by a storage module, model weights for the image generation module, decoder parameters for the decoder submodule, watermark reference patterns for the watermark embedding module and parameter configuration module, and query logs for use by the gradient monitoring module.

13. The method of claim 9, wherein the embedding step is performed after a final decoder layer of the deep generation model using a channel-wise or frequency-domain process.

14. The method of claim 9, wherein the decoder submodule is trained using watermarked images generated by the image generation module and processed by the watermark embedding module.

15. The method of claim 9, wherein the applying the controlled perturbations comprises applying a transformation defined by a positive definite matrix to the decoder output.

16. The method of claim 15, wherein eigenvalues of the positive definite matrix are selected to prevent convergence of loss values during training of a watermark removal model.

17. A system for secure verification and protection of watermarked images exposed via a decoder interface, comprising:
a decoder API module comprising:
a decoder submodule configured to receive a query image and extract a watermark representation using a trained decoder network; and
a decoder gradient shield submodule configured to apply controlled perturbations to outputs of the decoder submodule under detection of adversarial query behavior; and
a gradient monitoring module configured to observe query inputs and decoder outputs over time, identify characteristics indicative of model extraction attempts, and signal activation of the decoder gradient shield submodule based on detection outcomes.

18. The method of claim 17, wherein the decoder submodule is configured to return a null watermark output in response to query images that do not contain an embedded watermark, the null watermark output comprising an all-white image or a predefined neutral pattern.

19. The method of claim 17, wherein the decoder gradient shield submodule is configured to apply a matrix-based transformation to one or more output values of the decoder submodule, the transformation introducing directional offsets or scaling factors that alter gradient direction or magnitude during backpropagation.

20. The method of claim 17, wherein the decoder gradient shield submodule is selectively activated for query inputs that satisfy predefined adversarial criteria based on contextual query analysis, the criteria including repeated queries with minimal image variation, abnormally low entropy, or statistical similarity to known attack patterns.
